(19) United States
(12) Patent Application Publication
(10) Pub. No.: US 2026/0204288 A1
(43) Pub. Date: Jul. 16, 2026

(54) VIDEO PROCESSING METHOD AND DEVICE

(71) Applicant: Beijing Zitiao Network Technology Co., Ltd., Beijing (CN)

(72) Inventors: Ze WANG, Beijing (CN); Jiawen CHEN, Beijing (CN); Lin GAO, Beijing (CN); Xianfei TENG, Beijing (CN); Hongying GUO, Beijing (CN); Chunliu LIU, Beijing (CN); Xucheng LI, Beijing (CN); Haixuan CAO, Beijing (CN); Hao FU, Beijing (CN); Yuanpeng WANG, Beijing (CN)

(21) Appl. No.: 18/714,068

(22) PCT Filed: Nov. 21, 2022
(86) PCT No.: PCT/CN2022/133302

§ 371 Date: May 28, 2024

(30) Foreign Application Priority Data
Nov. 25, 2021 (CN) 202111415962.X

(51) Int. Cl. G11B 27/031; G11B 27/34

(52) U.S. Cl. CPC G11B 27/031; G11B 27/34

(57) ABSTRACT

Embodiments of the present disclosure provide a video processing method and device. The method includes: receiving an edit request for a target video; and presenting an edit page of the target video in response to the edit request, wherein a video track of the target video is presented on the edit page, an edit prompt identifier is presented on the video track, and the edit prompt identifier is configured to prompt a modification to the target video.

The present application is a U.S. National Stage Application under 35 U.S.C. § 371 of International Patent Application No. PCT/CN 2022/133302, filed on Nov. 21, 2022, which claims priority to Chinese Patent Application No. 202111415962.X, filed on Nov. 25, 2021, and entitled “VIDEO PROCESSING METHOD, AND DEVICE”, both of which are incorporated herein by reference in their entireties.

### TECHNICAL FIELD

Embodiments of the present disclosure relate to a video processing method and a device.

### BACKGROUND ART

Various types of applications may run on an electronic device, and different applications have different functions. For example, there are video applications for video processing. For the video applications, a video creator may edit a video before publishing the video.

### SUMMARY OF THE INVENTION

Embodiments of the present disclosure provide a video processing method and a device.

According to a first aspect, an embodiment of the present disclosure provides a video processing method. The method comprises:
receiving an edit request for a target video; and
presenting an edit page of the target video in response to the edit request, where a video track of the target video is presented on the edit page, an edit prompt identifier is presented on the video track, and the edit prompt identifier is used to prompt a modification to the target video.

According to a second aspect, an embodiment of the present disclosure provides a video processing apparatus. The apparatus comprises:
an edit request module configured to receive an edit request for a target video; and
an edit page presentation module configured to present an edit page of the target video in response to the edit request, where a video track of the target video is presented on the edit page, an edit prompt identifier is presented on the video track, and the edit prompt identifier is used to prompt a modification to the target video.

According to a third aspect, an embodiment of the present disclosure provides an electronic device. The electronic device comprises: at least one processor and a memory,
where the memory is configured to store computer-executable instructions; and
the at least one processor is configured to execute the computer-executable instructions stored in the memory to cause the electronic device to implement the method of the first aspect.

According to a fourth aspect, an embodiment of the present disclosure provides a computer-readable storage medium storing computer-executable instructions that, when executed by a processor, cause a computing device to implement the method of the first aspect.

According to a fifth aspect, an embodiment of the present disclosure provides a computer program product for implementing the method of the first aspect.

According to a sixth aspect, an embodiment of the present disclosure provides a computer program that, when executed by a processor, causes the method of the first aspect to be implemented.

### BRIEF DESCRIPTION OF DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show some embodiments of the present disclosure, and persons of ordinary skill in the art may still derive other accompanying drawings from these accompanying drawings without creative efforts.

FIG. 1 is a schematic diagram of a video usage scenario provided by a video application according to an embodiment of the present disclosure;

FIG. 2 is a flowchart of steps of a video processing method according to an embodiment of the present disclosure;

FIG. 3 is a schematic diagram of a structure of an edit page according to an embodiment of the present disclosure;

FIG. 4 is a schematic diagram of a structure of a content management page according to an embodiment of the present disclosure;

FIG. 5 is a schematic diagram of a structure of a problem details page according to an embodiment of the present disclosure;

FIG. 6 is a schematic diagram of a structure of an information modification page according to an embodiment of the present disclosure;

FIG. 7 is a block diagram of a structure of a video processing apparatus according to an embodiment of the present disclosure; and

FIG. 8 and FIG. 9 are block diagrams of structures of two electronic devices according to an embodiment of the present disclosure.

### DETAILED DESCRIPTION OF THE INVENTION

In order to make the objects, technical solutions and advantages of embodiments of the present disclosure clearer, the technical solutions in the embodiments of the present disclosure will be described clearly and completely below with reference to the accompanying drawings in the embodiments of the present disclosure. Obviously, the embodiments described are some of, rather than all of, the embodiments of the present disclosure. All the other embodiments obtained by those of ordinary skill in the art based on the embodiments of the present disclosure without any creative effort shall fall within the scope of protection of the present disclosure.

The embodiments of the present disclosure may be applied to video usage scenarios provided by video applications. FIG. 1 is a schematic diagram of a video usage scenario provided by a video application according to an embodiment of the present disclosure. Referring to FIG. 1, the video application is typically used in combination with a remote server. As a client, the video application can perform data exchange with the server. For example, as shown in FIG. 1, when a user USR1 needs to download a video, the user USR1 may operate a video application running on his or her terminal device to send a video data request to the server, and the server may send video data to the video application of the user USR1, thereby implementing video downloading. For another example, when a user USR2 needs to publish a video, the user may operate a video application running on his or her terminal device to send video data to the server, and the server may receive the video data and reply to the video application of the user USR2 with an indication message of publishing success.

It should be noted that FIG. 1 only exemplarily show video applications of two users. In practical application, the server may communicate with video applications of a plurality of users, and one user may use one or more video applications.

When receiving the video data sent by the video application of the USR2, the above server in FIG. 1 needs to first inspect the video data to determine whether video content, audio content, an introduction, a title, etc. comprised therein meet preset conditions. If the preset conditions are met, the video application is replied to with an indication message indicating that the video has been published successfully. If the preset conditions are not met, the video application is replied to with an indication message indicating that the video has failed the inspection. Then, the user needs to modify the video that has failed the inspection, to republish the video.

Usually, the user may edit the video before publishing the video, but the user needs to view video content and audio content frame by frame to determine which video frames and corresponding audio have a problem. Consequently, the user cannot quickly locate the parts to be improved of the video, which affects the user experience. After the video frames and corresponding audio that have a problem are determined, the video frames may be modified to eliminate the problem such that the video meets the preset conditions. In addition, after the video is published, if the user needs to edit the video, he/she usually needs to re-capture or re-upload a video and then edit and modify the video. The above video modification process is complex and comprises many steps that need to be operated by the user, resulting in a higher operation complexity for the user and reducing the efficiency of the user editing the video.

In order to solve the above problems, an edit page can be used to assist the user in modifying a target video in the embodiments of the present disclosure. Specifically, a video track may be displayed on the edit page, and an edit prompt identifier may be presented on the video track, where the edit prompt identifier is used to prompt a modification to a video frame indicated in the target video, so that the user can quickly modify and edit the video, thereby improving the efficiency of video editing, and improving the user experience.

The technical solutions of the embodiments of the present disclosure and how the technical solutions of the present disclosure solve the above technical problems are described in detail in the following specific embodiments. The following several specific embodiments may be combined with each other, and the same or similar concepts or processes may not be repeated in some embodiments. The embodiments of the present disclosure are described below with reference to the accompanying drawings.

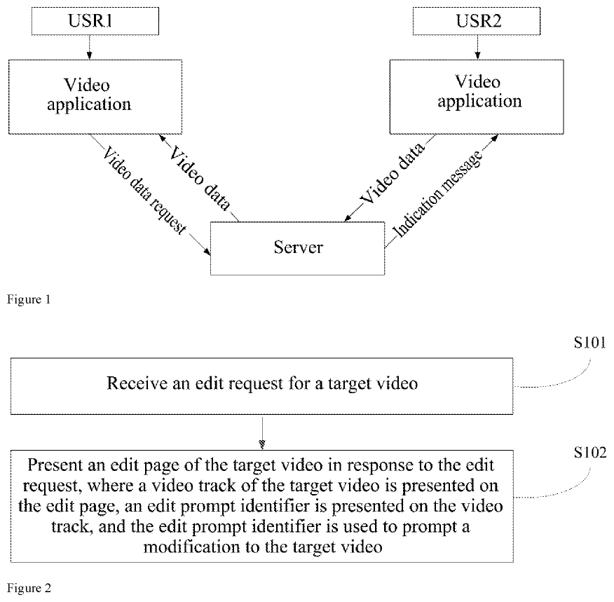

FIG. 2 is a flowchart of steps of a video processing method according to an embodiment of the present disclosure. The method shown in FIG. 2 may be applied to an electronic device. The video processing method comprises the following steps.
S101: Receive an edit request for a target video.

The target video is any video that needs to be edited. For example, the target video is a video that has failed the inspection, a video that has not been published successfully, or a video that is being published, and thus needs to be edited for republication and inspection.
S102: Present an edit page of the target video in response to the above edit request, where a video track of the target video is presented on the edit page, an edit prompt identifier is presented on the video track, and the edit prompt identifier is used to prompt a modification to the target video.

The edit prompt identifier may be, for example, a graphic identifier or a text identifier, which is highlighted on the video track. There is at least one edit prompt identifier in the target video, each edit prompt identifier corresponding to at least one piece of analysis information and/or modification advice information. The analysis information comprises, for example, video problem analysis, audio problem analysis, etc.

In an embodiment, the edit prompt identifier corresponds to a video frame and/or a video clip of the target video. For example, each edit prompt identifier corresponds to a start time and an end time. The start time corresponds to a time in the target video at which a start video frame corresponding to the edit prompt identifier appears. The end time corresponds to a time in the target video for an end video frame corresponding to the edit prompt identifier. When one edit prompt identifier corresponds to one video frame, the start video frame is the same as the end video frame, and the start time is the same as the end time. When one edit prompt identifier corresponds to a plurality of consecutive video frames, the start video frame is different from the end video frame, and the start time is different from the end time.

The above edit prompt identifier may be displayed on the video track, and a length of the video track is used to represent a duration of the target video. A length of the above edit prompt identifier on the video track is used to represent a duration between the corresponding start time and end time, and a plurality of edit prompt identifiers of the target video are sorted on the video track according to corresponding start times.

It should be understood that the video frame corresponding to the above edit prompt identifier may be a video frame having a problem. For example, the video frame may be a video frame where audio does not correspond to picture content, or a video frame with a blurred picture.

It should be noted that one problem may occur in one video frame or in a plurality of consecutive video frames. However, for one video frame or a plurality of consecutive video frames, there may be a plurality of problems, which are of different types. For example, for the first to tenth consecutive video frames in the target video, there may be two problems: an image content problem and an audio content problem.

In addition, problems occurring in non-consecutive video frames may be identified as two problems, with two edit prompt identifiers displayed on the video track. For example, a problem occurring in the first to tenth consecutive video frames in the target video and a problem occurring in the fifteenth to seventeenth consecutive video frames are identified as two problems, which correspond to two edit prompt identifiers.

Certainly, a plurality of video frames corresponding to different problems may comprise some overlapping video frames.

In the present disclosure, the edit prompt identifier is presented on the video track, where the edit prompt identifier is used to prompt a modification to the target video, so that the user can quickly obtain modification prompt information through the edit prompt identifier while viewing the video, which simplifies user operations and improves the user experience.

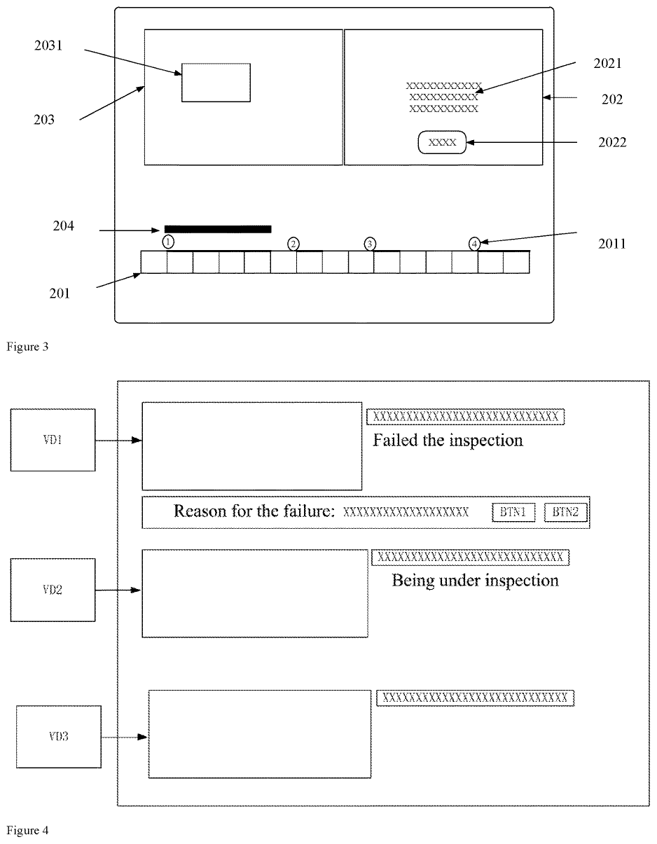

FIG. 3 is a schematic diagram of a structure of an edit page according to an embodiment of the present disclosure. Referring to FIG. 3, the edit page comprises at least a video track 201, an attribute area 202, and a video preview area 203. The video track 201 is used for displaying an edit prompt identifier 2011 in an order of start times. Edit prompt identifiers 2011 for four problems are shown on the video track 201 in FIG. 3.

In an embodiment, a target video frame or target video clip corresponding to a presentation position of the edit prompt identifier 2011 on the video track 201 is a target video frame or target video clip that is prompted for modification. For example, if the target video frame corresponding to the presentation position of the edit prompt identifier on the video track is the fifth video frame of the video, it indicates that the fifth video frame is to be edited.

It should be noted that the above video edit identifiers are arranged on the video track in a gradually increasing order from left to right, and the corresponding start times are also gradually increasing. That is, the start time t1 corresponding to the edit prompt identifier 1<the start time t2 corresponding to the edit prompt identifier 2<the start time t3 corresponding to the edit prompt identifier 3<the start time t4 corresponding to the edit prompt identifier 4.

Optionally, prior to S101, a publish operation for the target video may be further received. A publish status of the target video is detected in response to the publish operation for the target video.

The publish status comprises: being published, publishing success, and publishing failure.

When the publish status indicates publishing failure, it indicates that the target video needs to be edited. In this case, the edit prompt identifier may be presented on the video track. In this way, the user may be assisted in editing the target video, which facilitates improving the efficiency of editing the video that failed to be published.

When the publish status indicates publishing success, it indicates that the target video does not need to be edited. In this case, there is no need to present the edit prompt identifier on the video track.

Optionally, after the modification to the above target video, the edit prompt identifier on the video track is updated in response to a first trigger operation on a target detection control on the edit page.

The target detection control may be a control for indicating completion of the modification to the target video, or a control for refreshing the edit prompt identifier.

Specifically, the edit prompt identifiers may be updated after the problems corresponding to some or all of the edit prompt identifiers are fixed.

In the embodiments of the present disclosure, the status of the edit prompt identifier may be updated in a timely manner, such that the user may determine which edit prompt identifier has been modified and which has not been modified. The modified edit prompt identifier has a different status from that of the unmodified edit prompt identifier. The status may comprise at least one of the following: color, size, etc. For example, the modified edit prompt identifier is in a green color, and the unmodified edit prompt identifiers is in a red color. This helps the user to distinguish between modified and unmodified edit prompt identifiers, thereby improving the editing efficiency.

Optionally, before or after the target video is edited, a publish status of the target video is detected in response to a publish operation for the target video. For the publish status here, reference may be made to the foregoing description, which will not be repeated herein.

A second trigger operation that acts on the target video is received when the status of the target video indicates being published or publishing failure. A details page of the target video is presented in response to the second trigger operation.

Compared with the prior art, the present disclosure makes it possible that even for a video that failed to be published or is being published, the details page of the target video can be displayed in response to a trigger operation of a user to view the details page. Therefore, diversified needs of users are met, such that the users obtain detailed information of a video in advance before the video is published so as to adjust the video in a timely manner, which facilitates improving the user experience.

In the embodiments of the present disclosure, the user may be provided with the details page such that the user, especially the creator of the video, may view the video.

For example, for a video that is published at a scheduled time, the video will be in a status of being published before the video reaches a preset time. The display of a details page of the video that is being published is not supported in the prior art, but the embodiments of the present disclosure may provide a function to enter the details page to allow a user to view the video that is published at a scheduled time but has not reached the preset time.

The above video that is being published may comprise a video that is to be published for the first time and being published, or a video that is modified to be published and being published. Being published means that the video is being inspected.

Publishing failure may mean that the video has failed the inspection.

The above details page is used for displaying detailed information of the video. The details page comprises at least one of the following: a sub-interface for playing the video, a control for downloading the video, a sub-interface for displaying an introduction to the video, a sub-interface for displaying comments on the video, and a sub-interface for displaying historical playback data of the video.

The video played on the details page may be the original video or the modified video. This is not limited in the embodiments of the present disclosure.

Optionally, in the sub-interface for playing the video, watermark prompt information may be displayed. The watermark prompt information is used to prompt the status of the video: publishing failure, being under inspection, and publishing success.

The above details page may be entered via different pages, e.g., a content management page, a message notification page, or a publish feedback page. After the details page is entered via the different pages, different sub-interfaces of the details page may be entered. The sub-interfaces may be represented by tabs. For example, after the details page is entered via the message notification page, the details page may be displayed and then navigated to the sub-interface for displaying an introduction to the video on the details page. For another example, after the user clicks on a comment area of the video on the publish feedback page, the details page may be displayed and then navigated to the sub-interface for displaying comments on the video on the details page.

Certainly, the details page of the video that failed to be published or is being published may have different content from the details page of the video that has been published successfully. Specifically, part of the content is not displayed on the details page of the video that failed to be published or is being published, or the user is controlled to be unable to operate some controls. In this way, the user may be allowed to perform basic operations on the video that failed to be published or is being published, but restricted from performing some specific operations on the video, thereby avoiding adverse effects. For example, the user may be allowed to play the video, but not allowed to forward the video, and have a number of views, etc. of the video not displayed.

Optionally, analysis information and modification advice information for the target video are displayed in response to a third trigger operation on the edit prompt identifier.

The analysis information is an analysis of a reason why the edit prompt identifier is presented. It can be seen from the foregoing description that the edit prompt identifier is displayed when a problem occurs in a video frame. Therefore, the analysis information may be analysis information for this problem. For example, the analysis information may be analysis information about the reason for the problem. Specifically, the above analysis information is used to represent information obtained by analyzing a problem existing in the picture, audio, and subtitle of the target video, such as information indicating a blurred video picture.

Accordingly, the modification advice information indicates a corresponding modification advice provided for the problem existing in the picture, audio, and subtitle of the target video, i.e., a modification advice on how to remove the video edit identifier. For example, one video frame corresponds to one edit prompt identifier, the analysis information corresponding to the edit prompt identifier may indicate that an unallowed target object appears in the video frame, and the modification advice information may be pixelating a picture area where the target object is located.

In the embodiments of the present disclosure, the above analysis information and modification advice information may be used to prompt the user how to modify the video, so that the user can quickly and effectively modify the video, thereby further improving the modification efficiency.

Specifically, referring to FIG. 3, when the user clicks on a video edit identifier 1, detailed information 2021 corresponding to the video edit identifier 1 may be displayed in the attribute area 202 of FIG. 3. The detailed information 2021 may comprise the analysis information and the modification advice information. When the user clicks on a video edit identifier 2, detailed information 2021 for the video edit identifier 2 may be displayed in the attribute area 202 of FIG. 3.

Certainly, the user may switch between different video edit identifiers, to display detailed information for the currently selected video edit identifier in the attribute area.

Optionally, after the third trigger operation on the edit prompt identifier is received, a video track portion for the edit prompt identifier between the start video frame and the end video frame in the target video may be further highlighted. In this way, the user may be prompted which video frames of the target video have a problem, to further improve the efficiency of the user in editing the video frames.

The user may manually fix the target problem according to the above analysis information and modification advice information, or may click on a modification control to automatically fix the target problem. The operation process of the modification control is described in detail below.

Specifically, a modification control 2022 corresponding to the modification advice information is displayed in the above attribute area 202 shown in FIG. 3. The modification control 2022 is used to fix the target problem according to the corresponding modification advice information.

It should be noted that one video edit identifier may correspond to one or more pieces of modification advice information, and thus may correspond to a plurality of modification controls. The pieces of modification advice information are in a one-to-one correspondence with the modification controls. The user may perform a fourth trigger operation on one of the modification controls.

Thus, the target video is modified according to the modification advice information in response to the fourth trigger operation on the modification control.

Therefore, the user only needs to operate the modification control, without performing a plurality of complex operations, thereby improving the modification efficiency.

Optionally, referring to FIG. 3, the above edit page further comprises the video preview area 203. The video preview area 203 is used for preview of the target video. When the analysis information comprises the image content problem, a target video clip is displayed in the video preview area in response to a fifth trigger operation on the edit prompt identifier. The target video clip comprises at least one target video frame corresponding to the image content problem, and a picture area 2031 in the at least one target video frame that corresponds to the image content problem is highlighted on the at least one target video frame.

The above image content problem may comprise: an image simulation problem, or inconformity of image content to a preset rule.

In the embodiments of the present disclosure, the user may be prompted of a position where the image content problem occurs through the picture area highlighted in the above image preview area, thereby helping the user to quickly locate a local position corresponding to the problem. In addition, after the image content problem is fixed, the picture area highlighted in the image preview area may assist the user in viewing the modified image content, thereby implementing a comparison between the image content before and after the modification, which improves the user experience.

Certainly, for the above image content problem, the modification advice information may be adding a sub-image. The user may click on a corresponding sub-image add control to cover the picture area corresponding to the image content problem by using a predefine sub-image. In this simple manner, the image content problem can be fixed, and the efficiency of editing the video can be further improved.

Thus, when the user clicks on the modification control in the attribute area, the predefine sub-image may be directly covered on the picture area. This may avoid the case in which the picture area corresponding to the image content problem is identified only after the user clicks on the modification control, and can shorten the duration from clicking on the modification control to adding the sub-image, thereby improving the modification efficiency.

The sub-image may be any image that meets the preset conditions for inspecting the video, and the sub-image may be or may not be related to the image in the target video. For example, the sub-image may be a mosaic image. This method may be used in a scenario in which there is a relatively small image area with the image content problem and there is a relatively small number of video frames with the image content problem. It is possible to avoid the appearance of a sub-image unrelated to the target video in a relatively large number of video frames and a relatively large image area, thereby ensuring the viewing experience for the target video as much as possible.

Optionally, referring to FIG. 3, a sticker track 204 is displayed above the video track, and the sub-image is displayed on the sticker track 204. Then, a start video frame and an end video frame corresponding to the sub-image in the target video are adjusted according to an adjustment instruction for the sticker track 204.

The sticker track 204 is used to represent a time slice of the sub-image in the target video.

Referring to FIG. 3, the sticker track 204 above the video track 201 is not always displayed. Instead, it is displayed after, rather than before, the user clicks on the sub-image add control.

In an optional method, the user may drag the left end of the sticker track to adjust the start video frame of the sub-image in the target video forward or backward, and/or drag the right end of the sticker track to adjust the end video frame of the sub-image in the target video forward or backward.

In order to further improve the flexibility of adding the sub-image, it is also possible for the user to adjust attribute information of the sub-image. Specifically, an adjustment instruction for the sub-image is received first. Then, the attribute information of the sub-image is adjusted according to the adjustment instruction, where the attribute information of the sub-image comprises at least one of the following: size and shape.

The adjustment instruction may be an operation instruction for an adjust control in the attribute area. For example, the user may adjust the size, shape, etc. of the sub-image through the adjust control.

The process of fixing the image content problem is described above in detail. However, in practical application, the analysis information may further comprise the audio content problem. For example, an audio contains a mispronunciation. For another example, the audio contains content that does not correspond to the video. The fixing of the audio content problem is described in detail below.

For the audio content problem, the modification advice information may be muting. The user may click on a modification control corresponding to the muting, so as to completely reduce the volume of the audio corresponding to video frames where the audio content problem is located. The video frames corresponding to the audio content problem comprise a start video frame and an end video frame. Therefore, removing the audio corresponding to the video frames where the audio content problem is located may comprise: muting audio from the start video frame to the end video frame corresponding to the audio content problem in the target video. As such, the audio content problem can be fixed in this simple manner, which reduces the difficulty of modification.

The above muting may be implemented by setting the audio volume to 0%. This method may be used in a scenario in which there is a relatively small number of video frames with the audio content problem. It is possible to avoid a problem that more frames of images contain no sound, thereby ensuring the viewing experience for the target video as much as possible.

In the embodiments of the present disclosure, the modification advice information may be deletion for any type of problem, comprising the audio content problem and the image content problem.

Specifically, the user may click on a delete control to delete a video frame where the problem is located. This method may be used in a scenario in which there is a relatively large number of modifications and deleting the video frame has little effect. After the video frame is deleted, the edit prompt identifier for the problem is retained, to allow the user to view the problem after the problem has been fixed.

Optionally, after the target video is modified using any of the methods described above, the modification made to the target video may also be undone upon receipt of a modification undo operation. The undone modification may be a modification made to one or more video edit identifiers. For example, after the sub-image is added, the addition of the sub-image may be undone. For another example, after muting, the muting may be undone, i.e., the audio volume is adjusted to 100%. For yet another example, after the video frame is deleted, the deletion of the video frame may also be undone, i.e., the deleted video frame is restored to the target video. In this way, when the user is not satisfied with the modification, the modification may be undone, which improves the user's satisfaction with the result of the modification.

Optionally, based on the video track 201 and the above attribute area 202 shown in FIG. 3, in order to guide a new user to use them correctly, guide information may be displayed, to the new user, next to the edit prompt identifier for any problem on the video track and next to the attribute area, respectively. For example, the guide information “Video problem, click for details” may be displayed next to the edit prompt identifier for any problem on the video track, and the new user may perform an operation on the edit prompt identifier according to the guide information. For another example, the guide information “Video problem, view problem details and quickly fix the problem here” may be displayed next to the attribute area, and the new user may fix the problem according to the guide information.

Optionally, the above guide information next to the edit prompt identifier may be displayed after the edit page is started. The above guide information next to the attribute area may be displayed after the user clicks on the edit prompt identifier for the target problem.

Optionally, the above guide information is no longer displayed after the new user performs a click operation on any area of the edit page.

In an embodiment, a first prompt control and a second prompt control may be further displayed before the edit page of the target video is presented. Thus, the step of presenting the edit page of the target video is entered when a trigger operation on the first prompt control is received, so as to edit the target video through the aforementioned solution. At least one problem of the target video is automatically fixed when a trigger operation on the second prompt control is received, with no user operation required during the automatic fixing.

It can be seen that the user may choose whether to enter the automatic modification process or an auxiliary modification process, which improves the user's flexibility in use. The auxiliary modification process is a process of fixing a problem using the modification control on the edit page.

Optionally, after the user chooses the automatic modification process, an automatic modification prompt interface may be displayed to give a prompt that the automatic modification is in progress. For example, a mask is displayed over the entire screen, and “Automatically modifying” is displayed in the mask. After the completion of the automatic modification, the modification prompt interface may be closed, and a prompt that the automatic modification has been completed may be given.

Certainly, the user may undo the result of the automatic modification during or after the automatic modification process. Specifically, an undo operation for the automatic modification is received. The result of the automatic modification for the target video is undone and the step of presenting the edit page of the target video is entered, i.e., the auxiliary modification process is entered.

It can be seen that after undoing the result of the automatic modification, the user may make the auxiliary modification via the edit page. In this way, the user who is not satisfied with the result of the automatic modification may make an auxiliary modification according to the user's desire, which helps to improve the user experience.

Optionally, after the problem indicated by the edit prompt identifier is fixed, a prompt that the modification has been completed is given in the attribute area. Specifically, the prompt that the modification has been completed may be given by means of text, an image, a color, etc. For example, after the user clicks on the edit prompt identifier, the prompt that the edit prompt identifier has been implemented may be given by means of text “Completed” in the attribute area.

It should be understood that after the target video is modified via the above edit page, the modified target video is to be republished. If there is still a problem that has not been fixed, the user may be prompted whether to proceed with the submission. After the user confirms to proceed with the submission, the modified target video is republished. When the user undoes the continuation of the submission, the edit page is kept to allow the user to continue to modify the target video via the edit page.

After successful republication, it is also possible to go back to a first page, which is an entry page when the edit page is entered. The first page may comprise, but is not limited to: a content management page, a problem details page of the target video, and an information modification page of the target video. The content management page is used for managing at least one video, the at least one video comprising the target video. The problem details page comprises a problem description for the target video. The information modification page is used for making modifications to at least one of the following content of the target video: Cover, Title, and Introduction.

It should be understood that videos in the above content management page are those published by the creator, which may comprise a video that has passed the inspection and a video that has failed the inspection, and the video that has failed the inspection is the target video in the embodiments of the present disclosure.

FIG. 4 is a schematic diagram of a structure of a content management page according to an embodiment of the present disclosure. Referring to FIG. 4, three videos VD1, VD2, and VD3 are comprised on the content management page. VD1 is a video that has failed the inspection, VD2 is a video that is being under inspection, and VD3 is a video that has passed the inspection and has been published. Thus, the user may click on an operational control BTN1 below VD1 in FIG. 4. In this case, VD1 is used as the target video, and the user may make an auxiliary modification to VD1 via the edit page.

Certainly, the user may also click on an operational control BTN2 below VD1 in FIG. 4. Then, the problem details page of VD1 is entered. FIG. 5 is a schematic diagram of a structure of a problem details page according to an embodiment of the present disclosure. Referring to FIG. 5, VD1 comprises three problems: problem 1, problem 2, and problem 3, with a problem description of each problem displayed on the right side of the problem to allow the user to understand the problem. The problem description herein may comprise a problem of the cover, a problem of the introduction, a problem of the title, or a problem of the video content. The problem of the video content comprises, but is not limited to: the image content problem, the audio content problem, etc.

It can be seen that there are also two operational controls BTN1 and BTN3 shown in FIG. 5. The user may click on BTN1 to enter the edit page to make an auxiliary modification to VD1, and the user may also click on BTN3 to enter the information modification page of VD1.

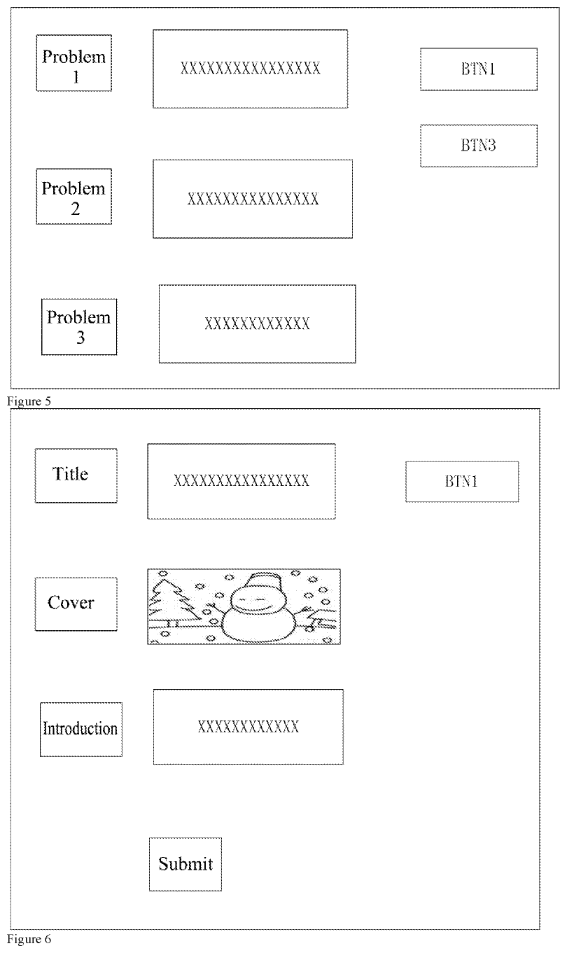

FIG. 6 is a schematic diagram of a structure of an information modification page according to an embodiment of the present disclosure. Referring to FIG. 6, the information modification page comprises at least: Title, Cover, and Introduction. The prompt information “Title” indicates that the text content on the right side thereof is title information, which may be modified by the user. The prompt information “Cover” indicates that an image on the right side thereof is the cover of the target video, and the user may re-upload a cover to complete a modification to the cover. The prompt information “Introduction” indicates that the text content on the right side thereof is the introduction to the target video, which may be modified by the user.

The user may click on “Submit” after modifying them through FIG. 6 so as to save the modified title, introduction, and cover.

Referring to FIG. 6, there is also comprised an operational control BTN1, on which the user may click to enter the edit page to make an auxiliary modification to the target video.

Certainly, the information modification page may further comprise some other information that needs or does not need to be modified, as well as other operational controls. For example, a source, a duration, a type, and other information of the target video may be displayed in FIG. 6. For another example, an operational control for re-uploading a video may be further displayed in FIG. 6, such that after clicking on the operational control, the user re-uploads a video to replace the original target video.

Corresponding to the video processing method in the above embodiments, FIG. 7 is a block diagram of a structure of a video processing apparatus according to an embodiment of the present disclosure. For ease of illustration, only parts related to this embodiment of the present disclosure are shown. Referring to FIG. 7, the video processing apparatus 300 comprises: an edit request module 301 and an edit page presentation module 302.

The edit request module 301 is configured to receive an edit request for a target video.

The edit page presentation module 302 is configured to present an edit page of the target video in response to the edit request, where a video track of the target video is presented on the edit page, an edit prompt identifier is presented on the video track, and the edit prompt identifier is used to prompt a modification to the target video.

Optionally, the apparatus further comprises:
an edit page update module configured to, after the modification to the target video, update the edit prompt identifier on the video track in response to a first trigger operation on a target detection control on the edit page.

Optionally, the apparatus further comprises:
a first publish status detection module configured to, before the edit request for the target video is received, detect a publish status of the target video in response to a publish operation for the target video. The edit prompt identifier being presented on the video track comprises: the edit prompt identifier being presented on the video track when the publish status indicates publishing failure.

Optionally, the apparatus further comprises:
a second publish status detection module configured to, before or after the target video is edited, detect a publish status of the target video in response to a publish operation for the target video;
a second operation receiving module configured to receive a second trigger operation that acts on the target video when the status of the target video indicates being published or publishing failure; and
a details page presentation module configured to present a details page of the target video in response to the second trigger operation.

Optionally, the apparatus further comprises:
a modification advice display module configured to display analysis information and modification advice information for the target video in response to a third trigger operation on the edit prompt identifier.

Optionally, the apparatus further comprises:
a modification control display module configured to display a modification control corresponding to the modification advice information; and
a first modification module configured to modify the target video according to the modification advice information in response to a fourth trigger operation on the modification control.

Optionally, the edit page further comprises a video preview area, and when the analysis information comprises an image content problem, the apparatus further comprises:
a target video determination and display module configured to display a target video clip in the video preview area in response to a fifth trigger operation on the edit prompt identifier, where the target video clip comprises at least one target video frame corresponding to the image content problem, and a picture area in the at least one target video frame that corresponds to the image content problem is highlighted on the at least one target video frame.

Optionally, the first modification module is further configured to:
cover the picture area corresponding to the image content problem by using a predefine sub-image.

Optionally, the apparatus further comprises:
a sticker track display module configured to display a sticker track above the video track, where the sub-image is displayed on the sticker track; and
a start-stop frame adjustment module configured to adjust a start video frame and an end video frame corresponding to the sub-image in the target video according to an adjustment instruction for the sticker track.

Optionally, when the analysis information comprises an audio content problem, the first modification module is further configured to:
mute audio from a start video frame to an end video frame corresponding to the audio content problem in the target video.

Optionally, the apparatus further comprises:
a select control display module configured to display a first prompt control and a second prompt control before the edit page of the target video is presented;
an edit page entry module configured to enter the step of presenting an edit page of the target video when a trigger operation on the first prompt control is received; and
a second modification module configured to automatically fix at least one problem of the target video when a trigger operation on the second prompt control is received, with no user operation required during the automatic fixing.

The video processing apparatus provided in this embodiment may be configured to perform the technical solution of the above method embodiment shown in FIG. 2. The implementation principles and technical effects thereof are similar, which are not repeated in this embodiment.

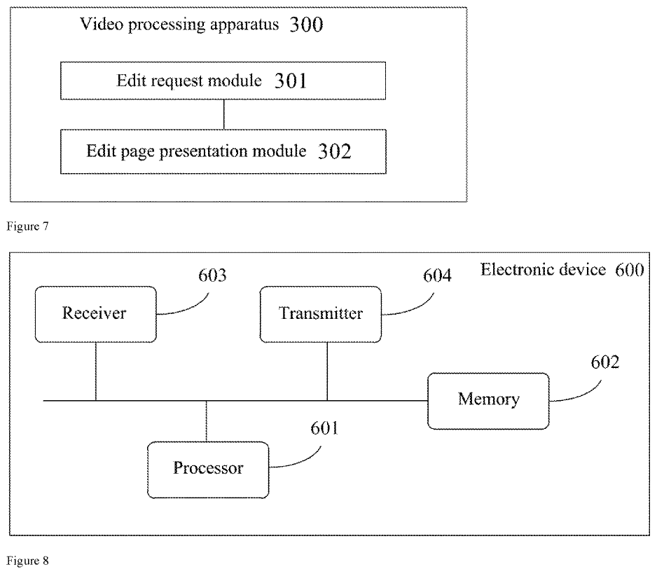

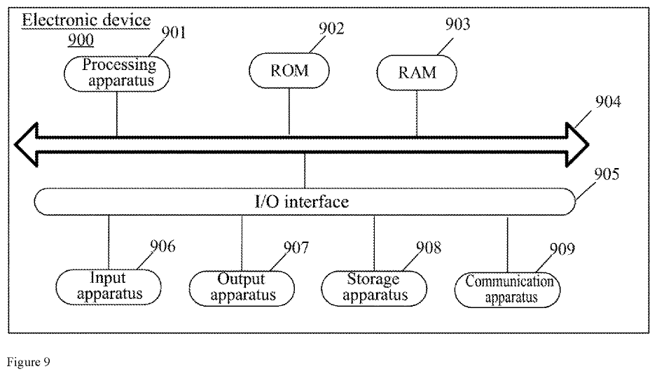

FIG. 8 is a block diagram of a structure of an electronic device 600 according to an embodiment of the present disclosure. The electronic device 600 comprises a memory 602 and at least one processor 601.

The memory 602 stores computer-executable instructions.

The at least one processor 601 executes the computer-executable instructions stored in the memory 602 to cause the electronic device 600 to implement the method as described in FIG. 2 above.

In addition, the electronic device may further comprise a receiver 603 and a transmitter 604. The receiver 603 is configured to receive information from other apparatuses or devices and forward the information to the processor 601. The transmitter 604 is configured to transmit information to other apparatuses or devices.

Further, reference is made to FIG. 9, which shows a schematic diagram of a structure of an electronic device 900 suitable for implementing an embodiment of the present disclosure. The electronic device 900 may be a terminal device. The terminal device may comprise, but is not limited to, a mobile terminal such as a mobile phone, a notebook computer, a digital broadcast receiver, a personal digital assistant (PDA), a tablet computer (portable android device, PAD), a portable media player (PMP), and a vehicle-mounted terminal (such as a vehicle navigation terminal), and a fixed terminal such as a digital TV and a desktop computer. The electronic device shown in FIG. 9 is merely an example, and shall not impose any limitation on the function and scope of use of the embodiments of the present disclosure.

As shown in FIG. 9, the electronic device 900 may comprise a processing apparatus (e.g., a central processor, a graphics processor) 901 that may perform a variety of appropriate actions and processing in accordance with a program stored in a read-only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 comprising, for example, a touch screen, a touchpad, a keyboard, a mouse, a camera, a microphone, an accelerometer, and a gyroscope; an output apparatus 907 comprising, for example, a liquid crystal display (LCD), a speaker, and a vibrator; the storage apparatus 908 comprising, for example, a tape and a hard disk; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure comprises a computer program product, which comprises a computer program carried on a computer-readable medium, where the computer program comprises program code for performing the method shown in the flowchart. In such an embodiment, the computer program may be downloaded and installed from a network through the communication apparatus 909, or installed from the storage apparatus 908, or installed from the ROM 902. When the computer program is executed by the processing apparatus 901, the above functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may comprise, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may comprise a data signal propagated in a baseband or as a part of a carrier, the data signal carrying computer-readable program code. The propagated data signal may be in various forms, comprising but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, comprising but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages comprise an object-oriented programming language, such as Java, Smalltalk, or C++, and further comprise conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, comprising a local area network (LAN) or a wide area network (WAN), or may be connected to an external computer (for example, connected via the Internet with the aid of an Internet service provider).

The flowchart and the block diagrams in the accompanying drawings illustrate the possibly implemented architecture, functions, and operations of the system, method, and computer program product according to the embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used comprise: a field-programmable gate array (FPGA), an application-specific integrated circuit (ASIC), application-specific standard parts (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may comprise, but is not limited to, electronic, magnetic, optical, electromagnetic, infrared, or semiconductor systems, apparatuses, or devices, or any suitable combination thereof. More specific examples of the machine-readable storage medium may comprise an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

In a first example of a first aspect, an embodiment of the present disclosure provides a video processing method. The method comprises:
receiving an edit request for a target video; and
presenting an edit page of the target video in response to the edit request, where a video track of the target video is presented on the edit page, an edit prompt identifier is presented on the video track, and the edit prompt identifier is used to prompt a modification to the target video.

Based on the first example of the first aspect, in a second example of the first aspect, the method further comprises:
after the modification to the target video, updating the edit prompt identifier on the video track in response to a first trigger operation on a target detection control on the edit page.

Based on the first example of the first aspect, in a third example of the first aspect, before the receiving an edit request for a target video, the method further comprises:
detecting a publish status of the target video in response to a publish operation for the target video; and
the edit prompt identifier being presented on the video track comprises:
the edit prompt identifier being presented on the video track when the publish status indicates publishing failure.

Based on the first example of the first aspect, in a fourth example of the first aspect, the method further comprises:
before or after the target video is edited, detecting a publish status of the target video in response to a publish operation for the target video;
receiving a second trigger operation that acts on the target video when the status of the target video indicates being published or publishing failure; and
presenting a details page of the target video in response to the second trigger operation.

Based on any one of the first to fourth examples of the first aspect, in a fifth example of the first aspect, the method further comprises:
displaying analysis information and modification advice information for the target video in response to a third trigger operation on the edit prompt identifier.

Based on the fifth example of the first aspect, in a sixth example of the first aspect, the method further comprises:
displaying a modification control corresponding to the modification advice information; and
modifying the target video according to the modification advice information in response to a fourth trigger operation on the modification control.

Based on the sixth example of the first aspect, in a seventh example of the first aspect, the edit page further comprises a video preview area, and when the analysis information comprises an image content problem, the method further comprises:
displaying a target video clip in the video preview area in response to a fifth trigger operation on the edit prompt identifier, where the target video clip comprises at least one target video frame corresponding to the image content problem, and a picture area in the at least one target video frame that corresponds to the image content problem is highlighted on the at least one target video frame.

Based on the seventh example of the first aspect, in an eighth example of the first aspect, the modifying the target video according to the modification advice information comprises:
covering the picture area corresponding to the image content problem by using a predefine sub-image.

Based on the eighth example of the first aspect, in a ninth example of the first aspect, the method further comprises:
displaying a sticker track above the video track, where the sub-image is displayed on the sticker track; and
adjusting a start video frame and an end video frame corresponding to the sub-image in the target video according to an adjustment instruction for the sticker track.

Based on the sixth example of the first aspect, in a tenth example of the first aspect, when the analysis information comprises an audio content problem, the modifying the target video according to the modification advice information comprises:
muting audio from a start video frame to an end video frame corresponding to the audio content problem in the target video.

Based on the first example of the first aspect, in an eleventh example of the first aspect, before the presenting an edit page of the target video, the method further comprises:
displaying a first prompt control and a second prompt control;
entering the step of presenting an edit page of the target video when a trigger operation on the first prompt control is received; and
automatically fixing at least one problem of the target video when a trigger operation on the second prompt control is received, with no user operation required during the automatic fixing.

In the first example of the second aspect, an embodiment of the present disclosure provides a video processing apparatus. The apparatus comprises:
an edit request module configured to receive an edit request for a target video; and
an edit page presentation module configured to present an edit page of the target video in response to the edit request, where a video track of the target video is presented on the edit page, an edit prompt identifier is presented on the video track, and the edit prompt identifier is used to prompt a modification to the target video.

Based on the first example of the second aspect, in a second example of the second aspect, the apparatus further comprises:
an edit page update module configured to, after the modification to the target video, update the edit prompt identifier on the video track in response to a first trigger operation on a target detection control on the edit page.

Based on the first example of the second aspect, in a third example of the second aspect, the apparatus further comprises:
a first publish status detection module configured to, before the edit request for the target video is received, detect a publish status of the target video in response to a publish operation for the target video.

The edit prompt identifier being presented on the video track comprises:
the edit prompt identifier being presented on the video track when the publish status indicates publishing failure.

Based on the first example of the second aspect, in a fourth example of the second aspect, the apparatus further comprises:
a second publish status detection module configured to, before or after the target video is edited, detect a publish status of the target video in response to a publish operation for the target video;
a second operation receiving module configured to receive a second trigger operation that acts on the target video when the status of the target video indicates being published or publishing failure; and
a details page presentation module configured to present a details page of the target video in response to the second trigger operation.

Based on any one of the first to fourth examples of the second aspect, in a fifth example of the second aspect, the apparatus further comprises:
a modification advice display module configured to display analysis information and modification advice information for the target video in response to a third trigger operation on the edit prompt identifier.

Based on the fifth example of the second aspect, in a sixth example of the second aspect, the apparatus further comprises:
a modification control display module configured to display a modification control corresponding to the modification advice information; and
a first modification module configured to modify the target video according to the modification advice information in response to a fourth trigger operation on the modification control.

Based on the sixth example of the second aspect, in a seventh example of the second aspect, the edit page further comprises a video preview area, and when the analysis information comprises an image content problem, the apparatus further comprises:
a target video determination and display module configured to display a target video clip in the video preview area in response to a fifth trigger operation on the edit prompt identifier, where the target video clip comprises at least one target video frame corresponding to the image content problem, and a picture area in the at least one target video frame that corresponds to the image content problem is highlighted on the at least one target video frame.

Based on the seventh example of the second aspect, in an eighth example of the second aspect, the first modification module is further configured to:
cover the picture area corresponding to the image content problem by using a predefine sub-image.

Based on the eighth example of the second aspect, in a ninth example of the second aspect, the apparatus further comprises:
a sticker track display module configured to display a sticker track above the video track, where the sub-image is displayed on the sticker track; and
a start-stop frame adjustment module configured to adjust a start video frame and an end video frame corresponding to the sub-image in the target video according to an adjustment instruction for the sticker track.

Based on the sixth example of the second aspect, in a tenth example of the second aspect, when the analysis information comprises an audio content problem, the first modification module is further configured to:
mute audio from a start video frame to an end video frame corresponding to the audio content problem in the target video.

Based on the first example of the second aspect, in an eleventh example of the second aspect, the apparatus further comprises:
a select control display module configured to display a first prompt control and a second prompt control before the edit page of the target video is presented;
an edit page entry module configured to enter the step of presenting an edit page of the target video when a trigger operation on the first prompt control is received; and
a second modification module configured to automatically fix at least one problem of the target video when a trigger operation on the second prompt control is received, with no user operation required during the automatic fixing.

According to a third aspect, one or more embodiments of the present disclosure provide an electronic device. The electronic device comprises: at least one processor and a memory,
where the memory is configured to store computer-executable instructions; and
the at least one processor is configured to execute the computer-executable instructions stored in the memory to cause the electronic device to implement the method of any one of the embodiments of the first aspect.

According to a fourth aspect, one or more embodiments of the present disclosure provide a computer-readable storage medium storing computer-executable instructions that, when executed by a processor, cause a computing device to implement the method of any one of the embodiments of the first aspect.

According to a fifth aspect, one or more embodiments of the present disclosure provide a computer program product for implementing the method of any one of the embodiments of the first aspect.

According to a sixth aspect, one or more embodiments of the present disclosure provide a computer program that, when executed by a processor, causes the method of any one of the embodiments of the first aspect to be implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are comprised in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A video processing method, comprising:
receiving an edit request for a video; and
presenting an edit page of the video in response to the edit request, wherein a video track of the video is presented on the edit page, edit prompt information is presented on the video track, and the edit prompt information is configured to prompt a modification to the video.

2. The video processing method according to claim 1, further comprising:
after the modification to the video, updating the edit prompt information on the video track in response to a first trigger operation on a target detection control on the edit page.

3. The video processing method according to claim 1, wherein before the receiving the edit request for the video, the video processing method further comprises:
detecting a publish status of the video in response to a publish operation for the video; and
the edit prompt information being presented on the video track comprises:
the edit prompt information being presented on the video track in response to the publish status indicating publishing failure.

4. The video processing method according to claim 1, further comprising:
before or after the video is edited, detecting a publish status of the video in response to a publish operation for the video;
receiving a second trigger operation that acts on the video in response to the publish status of the video indicating being published or publishing failure; and
presenting a details page of the video in response to the second trigger operation.

5. The video processing method according to claim 1, further comprising:
displaying analysis information and modification advice information for the video in response to a third trigger operation on the edit prompt information.

6. The video processing method according to claim 5, further comprising:
displaying a modification control corresponding to the modification advice information; and
modifying the video according to the modification advice information in response to a fourth trigger operation on the modification control.

7. The video processing method according to claim 6, wherein the edit page further comprises a video preview area, and the analysis information comprises an image content problem, and the video processing method further comprises:
displaying a video clip in the video preview area in response to a fifth trigger operation on the edit prompt information, wherein the video clip comprises at least one video frame corresponding to the image content problem, and a picture area in the at least one video frame that corresponds to the image content problem is highlighted on the at least one video frame.

8. The video processing method according to claim 7, wherein the modifying of the video according to the modification advice information comprises:
covering the picture area corresponding to the image content problem by using a predefine sub-image.

9. The video processing method according to claim 8, further comprising:
displaying a sticker track above the video track, wherein the predefine sub-image is displayed on the sticker track; and
adjusting a start video frame and an end video frame corresponding to the predefine sub-image in the video according to an adjustment instruction for the sticker track.

10. The video processing method according to claim 6, wherein the analysis information comprises an audio content problem, and the modifying of the video according to the modification advice information comprises:
muting audio between a start video frame and an end video frame corresponding to the audio content problem in the video.

11. (canceled)

12. An electronic device, comprising: at least one processor and a memory,
wherein the memory is configured to store computer-executable instructions; and
the at least one processor is configured to execute the computer-executable instructions stored in the memory to cause the electronic device to receive an edit request for a video; and
present an edit page of the video in response to the edit request, wherein a video track of the video is presented on the edit page, edit prompt information is presented on the video track, and the edit prompt information is configured to prompt a modification to the video.

13. A non-transitory computer-readable storage medium storing computer-executable instructions that, when executed by a processor, cause device the processor:
receive an edit request for a video; and
present an edit page of the video in response to the edit request, wherein a video track of the video is presented on the edit page, edit prompt information is presented on the video track, and the edit prompt information is configured to prompt a modification to the video.

14. (canceled)

15. (canceled)

16. The electronic device according to claim 12, wherein the at least one processor is further configured to execute the computer-executable instructions stored in the memory to cause the electronic device to, after the modification to the video, update the edit prompt information on the video track in response to a first trigger operation on a target detection control on the edit page.

17. The electronic device according to claim 12, wherein the at least one processor is further configured to execute the computer-executable instructions stored in the memory to cause the electronic device to detect a publish status of the video in response to a publish operation for the video; and
the edit prompt information being presented on the video track comprises:
the edit prompt information being presented on the video track in response to the publish status indicating publishing failure.

18. The electronic device according to claim 12, wherein the at least one processor is further configured to execute the computer-executable instructions stored in the memory to cause the electronic device to:
before or after the video is edited, detect a publish status of the video in response to a publish operation for the video;
receive a second trigger operation that acts on the video in response to the publish status of the video indicating being published or publishing failure; and
present a details page of the video in response to the second trigger operation.

19. The electronic device according to claim 12, wherein the at least one processor is further configured to execute the computer-executable instructions stored in the memory to cause the electronic device to display analysis information and modification advice information for the video in response to a third trigger operation on the edit prompt information.

20. The non-transitory computer-readable storage medium according to claim 13, wherein the computer-executable instructions, when executed by the processor, further cause the processor to, after the modification to the video, update the edit prompt information on the video track in response to a first trigger operation on a target detection control on the edit page.

21. The non-transitory computer-readable storage medium according to claim 13, wherein the computer-executable instructions, when executed by the processor, further cause the processor to detect a publish status of the video in response to a publish operation for the video; and
the edit prompt information being presented on the video track comprises:
the edit prompt information being presented on the video track in response to the publish status indicating publishing failure.

22. The non-transitory computer-readable storage medium according to claim 13, wherein the computer-executable instructions, when executed by the processor, further cause the processor to:
before or after the video is edited, detect a publish status of the video in response to a publish operation for the video;
receive a second trigger operation that acts on the video in response to the publish status of the video indicating being published or publishing failure; and
present a details page of the video in response to the second trigger operation.

23. The non-transitory computer-readable storage medium according to claim 13, wherein the computer-executable instructions, when executed by the processor, further cause the processor to display analysis information and modification advice information for the video in response to a third trigger operation on the edit prompt information.
